(19) United States
(12) Patent Application Publication
(10) Pub. No.: US 2014/0281592 A1
(43) Pub. Date: Sep. 18, 2014

(54) Global Efficient Application Power Management

(71) Applicant: ADVANCED MICRO DEVICES, INC., Sunnyvale, CA (US)

(72) Inventors: William L. BIRCHER, Austin, TX (US); Donald W. Cherepacha, Oakville (CA); Adam N.C. Clark, Toronto (CA)

(73) Assignee: Advanced Micro Devices, Inc., Sunnyvale, CA (US)

(21) Appl. No.: 13/846,558

(22) Filed: Mar. 18, 2013

(51) Int. Cl. G06F 1/26

(52) U.S. Cl. CPC G06F 1/26
USPC 713/300

(57) ABSTRACT

A method, system and computer-readable medium for allocating power among computing resources are provided. The method calculates an activity level of a first computer resource. When the activity level is less than a threshold value, the method increases the power allocation to a second computing resource. When the activity level exceeds the threshold value, the method decreases the power allocation to the second computing resource.

### BACKGROUND

1. Field

Embodiments relate generally to power management and, in particular, to power allocation among computing resources.

2. Background

Allocating power to computing resources requires consideration of multiple factors that affect temperature and performance. For example, allocating increased power to a computing resource can increase performance by allowing the resource to perform computations faster. However, increased power consumption can also lead to increased temperatures, which can damage components or create dangerous fire hazards. For this reason, power supplied to computing environments is typically managed in order to prevent extreme temperatures, but while taking into account efficiency.

Existing power management schemes allocate power to resources in a straightforward manner. For example, some schemes allocate power in a “greedy” fashion, allowing a resource to consume as much power as possible until a temperature limit is reached. However, when this limit is reached, the power is decreased to all resources to prevent overheating. This type of scheme is detrimental to efficiency, because it allows resources to more readily reach the temperature limit, which in turn may cause a decrease in power to all resources regardless of their power needs.

### BRIEF SUMMARY

What are needed are mechanisms that allocate power among computing resources depending on their needs for a particular workload, in order to maximize efficiency.

A method, system and computer-readable medium for allocating power among computing resources are provided. The method calculates an activity level of a first computer resource. When the activity level is less than a threshold value, the method increases the power allocation to a second computing resource. When the activity level exceeds the threshold value, the method decreases the power allocation to the second computing resource.

Further features and advantages of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the relevant art(s) to make and use the embodiments.

FIG. 1 depicts a block diagram of an illustrative computing operating environment, according to an embodiment.

FIG. 2 illustrates a bottleneck scenario in thermally coupled resources, according to an embodiment.

FIG. 3 depicts a flowchart illustrating a method by which a power allocating unit can detect and mitigate bottlenecks between a first and a second resource, according to an embodiment.

FIG. 4 is an illustration of an example computer system in which embodiments, or portions thereof, can be implemented.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments” does not require that all embodiments include the discussed feature, advantage or mode of operation. Alternate embodiments may be devised without departing from the scope of the disclosure, and well-known elements of the disclosure may not be described in detail or may be omitted so as not to obscure the relevant details. In addition, the terminology used herein is for the purpose of describing particular embodiments only and is not intended to be limiting of the disclosure. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Embodiments are directed at efficiently allocating power between thermally coupled computing resources. When resources are thermally coupled, the temperature in one component will affect the temperature of the other components. In certain embodiments, an power allocation is achieved for thermally coupled resources that are collaboratively working a common workload with the goal of maximizing efficiency, where efficiency can be defined as computation rate per amount of power consumed.

FIG. 1 depicts a block diagram of an illustrative computing operating environment 100, according to an embodiment. In one example, operating environment 100 includes a computing component 110, a power management unit 150 and a power source 160.

In one example, computing component 110 can be an integrated circuit comprising a central processing unit (CPU) and a graphics processing unit (GPU). In another example, computing component 110 can be a portion of a motherboard. In another example, computing component 110 can be a rack of servers. Other possibilities for computing component 110 will be envisioned by those skilled in the relevant arts and are meant to be encompassed herein.

In one example, computing component 110 comprises a resource 120 and a resource 130. In an embodiment, resources 120 and 130 are thermally coupled, meaning that the temperature of each of the resources affects the other resource. For example, when resource 120 is performing computations for a sustained period of time, the temperature of resource 120 increases. This increase in the temperature of resource 120 in turn can cause an increase in the temperature of resource 130.

In an embodiment, resources 120 and 130 are thermally coupled due to their close proximity. In one example, resources 120 and 130 are different components of an integrated circuit, such as a CPU and a graphics processing unit GPU in a single die. In one example, resources 120 and 130 are a separate CPU and a GPU in a motherboard. In one example, resources 120 and 130 are different servers in a rack of servers. Other possibilities for thermally coupled computing resources will be envisioned by those skilled in the relevant arts and are meant to be encompassed herein.

In an embodiment, power management unit 150 can be configured to supply power from power source 160 to individual resources within computing component 110. In one example, power management unit 150 can individually adjust the amount of power allocated to resource 120 and resource 130. In an embodiment, power management unit 150 implements an overheating protection mechanism that reduces the power allocation to one or more resources depending on the temperature. In one example, resources 120 and 130 may contain temperature sensors 122 and 132, respectively. In an embodiment, power management unit 150 uses temperature sensors 122 and 132 to implement the overheating protection mechanism. For example, power management unit 150 can monitor whether one or more of the temperature sensors reaches a temperature limit. If a temperature reaches a certain limit, power management unit 150 can reduce the power supplied to one or more resources. It should be understood that although the temperature sensors are described as forming part of the resources, the temperature sensors may be external to the resources, as will be envisioned by those skilled in the relevant arts. It should also be understood that any methods or devices for measuring temperature as envisioned by those skilled in the relevant arts could be used to perform the functions of temperature sensors, and such methods or devices are meant to be encompassed herein.

In an embodiment, power management unit 150 can be further configured to monitor the activity level of resources within computing component 110. For example, power allocating unit 150 may receive information that can be used to determine the ratio or percentage of time that a resource is active, i.e., performing computations. In an embodiment, power allocating unit can calculate the activity level for a resource as the ratio of the active time and the sum of the active time and the idle time, i.e., Active Time/(Active Time+Idle Time).

In an embodiment, power management unit 150 can use this activity level computation to detect a bottleneck between resources and adjust the power allocations to resolve this bottleneck. For example, assume two resources are both working on a single workload. If one of the resources processes data faster than the other, the faster of the two resources may need to wait for the slower one to finish processing data. This results in an inefficient use of the faster resource due to the bottleneck created by the slower resource.

In an embodiment, the bottleneck problem gets compounded in environments with thermally coupled resources. In the above scenario, the slower resource is working continuously because it never has to wait for the faster resource to process data. As a result, the temperature of this slower resource will rise. Because the resources are thermally coupled, this will in turn cause the temperature of the other resource to rise as well. This rise in temperature can cause the overheating protection mechanism of power management unit 150 to decrease the power allocation of the resources, which would result in even slower performance.

FIG. 2 illustrates the bottleneck scenario in thermally coupled resources, according to an embodiment. In this scenario, resource 120 processes data and issues work to a shared queue 210, and resource 130 processes data from queue 210.

In an embodiment, resource 120 processes data at a faster rate than resource 130. This may be due, for example, to resource 120 having a higher processing capacity or having to perform simpler computations with the data. In this case, queue 210 will be fall, or nearly full, because resource 120 is issuing work to queue 210 faster than resource 130 can process the work. Since resource 130 is working at full capacity, the temperature in resource 120 may increase. Because the resources are thermally coupled, the temperature of resource 120 may also increase. This may cause further decrease in performance, since power management unit 150 may trigger its overheating protection mechanism and decrease the power allocation to the resources, as described above with reference to FIG. 1.

If, on the other hand, resource 130 processes data faster than resource 120, then queue 210 may be empty, or nearly empty, because resource 130 is processing work faster than resource 120 can issue it. In this scenario, resource 120 is working at or near full capacity and the temperature of resource 120 can increase. Again, because the resources are thermally coupled, the temperature of resource 130 can also increase, and can cause the overheating protection mechanism to be triggered.

In order to mitigate this bottleneck in thermally coupled resources collaborating on a single workload, power management unit 150 can efficiently adjust the power allocation to the resources in order to prevent overheating. For example, power management unit 150 can monitor the activity level of a resource in order to determine if the resource is working at or near full capacity. For example, if the resource 130 is working at or near full capacity, power management unit 150 can reduce the power allocation to resource 120. This saves unnecessary power consumption by resource 120, which may be sitting idle waiting for resource 130 to process data. Conversely, if resource 130 is working at substantially less than its capacity, then power management unit 150 can increase the power allocation to resource 120. This can cause resource 120 to issue work faster and fill up the queue.

FIG. 3 depicts a flowchart 300 illustrating a method by which power allocating unit 150 can detect and mitigate bottlenecks between a first and a second resource, which can be thermally coupled and working on a common workload, according to an embodiment. Not all steps need be performed, nor performed in the order shown.

At step 310, the power management unit reads the average activity for a period of time for a Resource 130. Power management unit can read this information from the resource itself, or from another component in the computing environment. Other mechanisms of obtaining the activity time for a resource will be recognized by those skilled in the relevant arts, and are meant to be encompassed herein.

At step 320, the power management unit computes an activity level for Resource 130 and compares it to a threshold. The activity level can be calculated, for example, according to the formula ActivityLevel=Active Time/(Active Time+Idle). The threshold can be a predetermined value, or can be adjusted to find a value that yields optimum performance value in the particular environment. Other mechanisms of measuring activity level and determining a threshold will be recognized by those skilled in the relevant arts, and are meant to be encompassed herein.

If at step 320 the power management unit determines the activity level is greater than the threshold, the power management unit proceeds to step 330 and increases the power allocated to a Resource 120. As explained above, this can result in increased performance for Resource 120 due to the increased power.

On the other hand, if at step 320 the power management unit determines the activity level is less than the threshold, the power management unit proceeds to step 340 and decreases the power allocated to Resource 120. As explained above, this can result in lowering the overall temperature which can avoid a decrease in performance of the resources.

At step 350, the power management unit waits for a period of time before jumping back to step 310 and reassessing the power allocation of the resource.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the present embodiments. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Various aspects of embodiments of the present embodiments may be implemented in software, firmware, hardware, or a combination thereof. FIG. 4 is an illustration of an example computer system 400 in which embodiments, or portions thereof, can be implemented as computer-readable code. For example, the methods illustrated in the present disclosure can be implemented in portions system 400. Various embodiments are described in terms of this example computer system 400. After reading this description, it will become apparent to a person skilled in the relevant art how to implement embodiments using other computer systems and/or computer architectures.

It should be noted that the simulation, synthesis and/or manufacture of various embodiments may be accomplished, in part, through the use of computer readable code, including general programming languages (such as C or C++), hardware description languages (HDL) such as, for example, Verilog HDL, VHDL, Altera HDL (AHDL), other available programming and/or schematic capture tools (such as circuit capture tools), or hardware-level instructions implementing higher-level machine code instructions (e.g., microcode). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core (e.g., a CPU core) that is embodied in program code and can be transformed to hardware as part of the production of integrated circuits.

Computer system 400 includes one or more processors, such as processor 404. Processor 404 may be a special purpose or a general-purpose processor. For example, in an embodiment, CPU 110 of FIG. 1 may serve the function of processor 404. Processor 404 is connected to a communication infrastructure 406 (e.g., a bus or network).

Computer system 400 also includes a main memory 408, preferably random access memory (RAM), and may also include a secondary memory 410. Secondary memory 410 can include, for example, a hard disk drive 412, a removable storage drive 414, and/or a memory stick. Removable storage drive 414 can include a floppy disk drive, a magnetic tape drive, an optical disk drive, a flash memory, or the like. The removable storage drive 414 reads from and/or writes to a removable storage unit 418 in a well-known manner. Removable storage unit 418 can comprise a floppy disk, magnetic tape, optical disk, etc. which is read by and written to by removable storage drive 414. As will be appreciated by persons skilled in the relevant art, removable storage unit 418 includes a computer-usable storage medium having stored therein computer software and/or data.

In alternative implementations, secondary memory 410 can include other similar devices for allowing computer programs or other instructions to be loaded into computer system 400. Such devices can include, for example, a removable storage unit 422 and an interface 420. Examples of such devices can include a program cartridge and cartridge interface (such as those found in video game devices), a removable memory chip (e.g., EPROM or PROM) and associated socket, and other removable storage units 422 and interfaces 420 which allow software and data to be transferred from the removable storage unit 422 to computer system 400.

Computer system 400 can also include a communications interface 424. Communications interface 424 allows software and data to be transferred between computer system 400 and external devices. Communications interface 424 can include a modem, a network interface (such as an Ethernet card), a communications port, a PCMCIA slot and card, or the like. Software and data transferred via communications interface 424 are in the form of signals which may be electronic, electromagnetic, optical, or other signals capable of being received by communications interface 424. These signals are provided to communications interface 424 via a communications path 426. Communications path 426 carries signals and can be implemented using wire or cable, fiber optics, a phone line, a cellular phone link, a RF link or other communications channels.

In this document, the terms “computer program medium” and “computer-usable medium” are used to generally refer to media such as removable storage unit 418, removable storage unit 422, and a hard disk installed in hard disk drive 412. Computer program medium and computer-usable medium can also refer to memories, such as main memory 408 and secondary memory 410, which can be memory semiconductors (e.g., DRAMs, etc.). These computer program products provide software to computer system 400.

Computer programs (also called computer control logic) are stored in main memory 408 and/or secondary memory 410. Computer programs may also be received via communications interface 424. Such computer programs, when executed, enable computer system 400 to implement embodiments as discussed herein. In particular, the computer programs, when executed, enable processor 404 to implement processes of embodiments, such as the steps in the methods illustrated by the flowcharts of the figures discussed above. Accordingly, such computer programs represent controllers of the computer system 400. Where embodiments are implemented using software, the software can be stored in a computer program product and loaded into computer system 400 using removable storage drive 414, interface 420, hard drive 412, or communications interface 424.

Embodiments are also directed to computer program products including software stored on any computer-usable medium. Such software, when executed in one or more data processing device, causes a data processing device(s) to operate as described herein. Embodiments employ any computer-usable or -readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

What is claimed is:

1. A computer-implemented method comprising:
calculating an activity level of a first computer resource;
when the activity level exceeds a threshold value, increasing the power allocation to a second computing resource; and
when the activity level is less than the threshold value, decreasing the power allocation to the second computing resource.

2. The method of claim 1, wherein a temperature of the first resource affects a temperature of the second resource.

3. The method of claim 1, wherein the first resource and the second resource compute portions of a single workload.

4. The method of claim 1, wherein the activity level comprises a ratio of an active time and the sum of the active time and an idle time for the first computing resource.

5. The method of claim 1, wherein the threshold value is one.

6. The method of claim 1, wherein the first and second computing resources comprise portions of a single integrated circuit die.

7. The method of claim 1, wherein the first resource is a central processing unit and the second resource is a graphics processing unit.

8. The method of claim 1, wherein the first and second computing resources comprise servers in a rack of servers.

9. A system comprising:
a computing component comprising a first resource and a second resource; and
a power management unit configured for:
calculating an activity level of a first computer resource;
when the activity level exceeds a threshold value, increasing the power allocation to a second computing resource; and
when the activity level is less than the threshold value, decreasing the power allocation to the second computing resource.

10. The system of claim 9, wherein a temperature of the first resource affects a temperature of the second resource.

11. The system of claim 9, wherein the first resource and the second resource compute portions of a single workload.

12. The system of claim 9, wherein the activity level comprises a ratio of an active time and the sum of the active time and an idle time for the first computing resource.

13. The system of claim 9, wherein the threshold value is one.

14. The system of claim 9, wherein the first and second computing resources comprise portions of a single integrated circuit die.

15. The system of claim 9, wherein the first resource is a central processing unit and the second resource is a graphics processing unit.

16. The system of claim 9, wherein the first and second computing resources comprise servers in a rack of servers.

17. A computer-readable storage medium having instructions stored thereon, execution of which by a processor cause the processor to perform operations, the operations comprising:
calculating an activity level of a first computer resource;
when the activity level exceeds a threshold value, increasing the power allocation to a second computing resource; and
when the activity level is less than the threshold value, decreasing the power allocation to the second computing resource.

18. The computer-readable storage medium of claim 17, wherein a temperature of the first resource affects a temperature of the second resource.

19. The computer-readable storage medium of claim 17, wherein the first resource and the second resource compute portions of a single workload.

20. The computer-readable storage medium of claim 17, wherein the activity level comprises a ratio of an active time and the sum of the active time and an idle time for the first computing resource.

21. The computer-readable storage medium of claim 17, wherein the threshold value is one.

22. The computer-readable storage medium of claim 17, wherein the first and second computing resources comprise portions of a single integrated circuit die.

23. The computer-readable storage medium of claim 17, wherein the first resource is a central processing unit and the second resource is a graphics processing unit.

24. The computer-readable storage medium of claim 17, wherein the first and second computing resources comprise servers in a rack of servers.
